(19) United States
(12) Patent Application Publication
(10) Pub. No.: US 2026/0209454 A1
(43) Pub. Date: Jul. 23, 2026

(54) NEW POLYMER AND ANION EXCHANGE MEMBRANE COMPRISING SAME

(71) Applicant: HANWHA SOLUTIONS CORPORATION, Seoul (KR)

(72) Inventors: Du Yeol RYU, Seoul (KR); Jong Hak KIM, Seoul (KR); Seungbae JEON, Seoul (KR); Jinhee KIM, Seoul (KR)

(73) Assignee: HANWHA SOLUTIONS CORPORATION, Seoul (KR)

(21) Appl. No.: 19/138,998

(22) PCT Filed: Dec. 11, 2023
(86) PCT No.: PCT/KR2023/020314

§ 371 Date: Jun. 13, 2025

(30) Foreign Application Priority Data
Dec. 16, 2022 (KR) 10-2022-0176765

(51) Int. Cl. C08J 5/22; C08F 26/02

(52) U.S. Cl. CPC C08J 5/2243; C08F 26/02

(57) ABSTRACT

A novel polymer and an anion exchange membrane contains the novel polymer are disclosed. The anion exchange membrane has improved ion conductivity and durability. A method for producing the polymer is also disclosed. The novel polymer is represented by the following Chemical Formula 1:

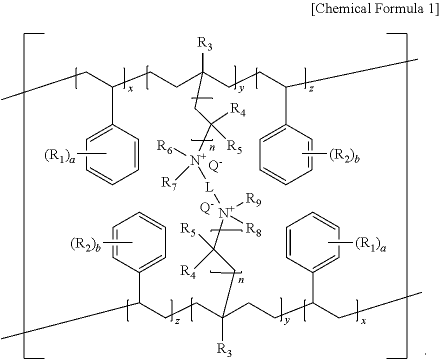

### CROSS-REFERENCE TO RELATED APPLICATION(S)

This application claims the benefit of Korean Patent Application No. 10-2022-0176765 filed on Dec. 16, 2022 with the Korean Intellectual Property Office, the disclosure of which is incorporated herein by reference in its entirety.

The present invention relates to a novel polymer and an anion exchange membrane comprising the same and thus having improved ion conductivity and durability.

### Technical Field

### Background Art

Anion exchange membranes refer to membranes that has positively charged ionic groups, which make it difficult for cations to pass through due to the repulsion of the same electric charges, and selectively allow only anions to pass through.

Since alkaline electrolysis cells(AEC) using such anion exchange membranes can use low-priced metals such as nickel and manganese as electrode catalysts instead of a precious metal platinum, it can overcome the drawbacks (high price, fuel crossover, etc.) of existing commercially available cation exchange membranes based on the advantage of low price, and thus can be widely used in electrochemical devices such as fuel cells, water electrolytic cells, and redox flow cells.

However, the anion exchange membranes up to the present have lower ion conductivity as compared to cation exchange membranes and have difficulties in commercializing due to chemical/mechanical stability issues under basic conditions. Therefore, in order to develop AEC water electrolytic cells to ensure competitiveness in hydrogen production, a technology is needed to manufacture high-performance, highly durable anion exchange membranes at a lower cost than before.

Therefore, there is a continuing demand for the development of anion exchange membranes that are cost-competitive and have improved ionic conductivity and durability.

### DETAILED DESCRIPTION OF THE INVENTION

### Technical Problem

It is an object of the present disclosure to provide a novel polymer, a method for producing the same, an anion exchange membrane comprising the novel polymer and thus having improved ion conductivity and durability, and a method for producing the anion exchange membrane.

### Technical Solution

According to one embodiment of the present invention, there is provided a polymer comprising a crosslinked structure represented by the following Chemical Formula 1:

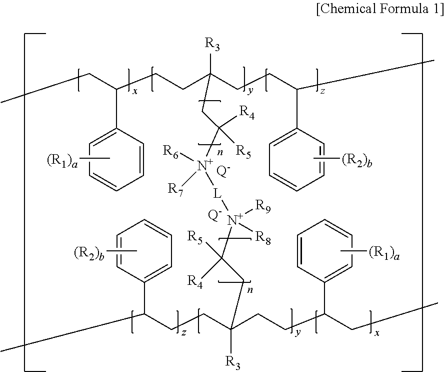

wherein, in Chemical Formula 1,
R₁ and R₂ are each independently halogen or a C₁₋₄ alkyl,
a and b are each independently an integer from 0 to 3,
R₃ and R₄ are each independently hydrogen or a C₁₋₄ alkyl,
R is a C₁₋₁₀ alkyl,
R₆ to R₉ are each independently a C₁₋₄ alkyl,
L is a C₁₋₁₀ alkylene,
Q is halogen,
n is an integer from 1 to 3, and
x, y and z each means the mole fraction of each repeating unit in the polymer.

According to another embodiment of the present invention, there is provided a method for producing a polymer comprising a crosslinked structure represented by the following Chemical Formula 1, the method comprising the steps of:
reacting a first polymer, which is an A-B-C triblock copolymer represented by the following Chemical Formula 1-1, with a hydrogen halide to produce a second polymer, which is an A-B′-C triblock copolymer represented by the following Chemical Formula 1-2 (step 1);
reacting a second polymer represented by the following Chemical Formula 1-2 with an alkene represented by the following Chemical Formula 1a to produce a third polymer, which is an A-B″-C triblock copolymer represented by Chemical Formula 1-3 (step 2); and
reacting a third polymer represented by the following Chemical Formula 1-3 with a diamine represented by the following Chemical Formula 1b to produce a polymer comprising a crosslinked structure represented by Chemical Formula 1 (step 3):

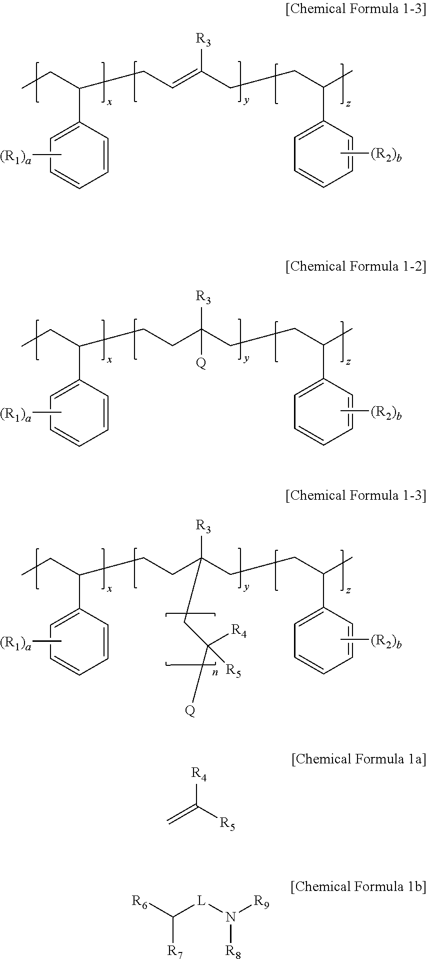

wherein, in Chemical Formulas 1-1 to 1-3, 1a and Tb,
R₁ to R₉, L, Q, a, b, n, x, y and z are as defined in Chemical Formula 1.

According to another embodiment of the present invention, there is provided an anion exchange membrane comprising the above-mentioned polymer.

According to yet another embodiment of the present invention, there is provided a method for producing an anion exchange membrane, the method comprising the steps of:
reacting a third polymer represented by Chemical Formula 1-3 with a diamine represented by Chemical Formula 1b in an organic solvent to produce a polymer solution comprising a crosslinked structure represented by Chemical Formula 1 (step 1); and
casting the polymer solution onto a substrate and then drying the casted film (step 2).

### Advantageous Effects

The novel polymer of the present invention not only reduces the cost of the preparation process by using a styrene-isoprene-styrene triblock copolymer, which has the advantage that the synthesis process is simple and the process cost is low, but also can subsequently lengthen a distance between the ionic bond and the main chain through atom transfer radical polymerization of the copolymer, thereby improving the ionic conductivity of the anion exchange membrane comprising the same. In addition, fine phase separation is achieved through the formation of several tens of nanostructures, which facilitates the movement of ions through nanochannels, and the mechanical strength is extremely superior to that of a single polymer, thereby improving the durability of an anion exchange membrane comprising the polymer.

### BRIEF DESCRIPTION OF THE DRAWINGS

FIG. 1 is a photograph of the anion exchange membrane produced in Example 1.

FIG. 2 shows the ¹H NMR analysis spectra of the second polymer (SIS-Cl) and the third polymer (SIS-hex-Cl) produced in Example 1.

FIG. 3 shows the ¹H NMR analysis spectrum of the first polymer (SIS), which is the starting material of Example 1.

FIG. 4 shows the FT-IR analysis spectra of the first polymer (SIS), which is the starting material of Example 1 and the second polymer (SIS-Cl), the third polymer (SIS-hex-Cl), and the anion exchange membrane (Xl-SIS-hex-QA) produced in Example 1.

### DETAILED DESCRIPTION OF THE EMBODIMENTS

Technical terms used herein is for the purpose of describing exemplary embodiments only and is not intended to limit the scope of the invention. The singular forms “a,” “an” and “the” are intended to include plural forms, unless the context clearly indicates otherwise. It should be understood that the terms “comprise,” “include”, “have”, etc. are used herein to specify the presence of stated features, integers, steps, components or combinations thereof, but do not preclude the presence or addition of one or more other features, integers, steps, components, or combinations thereof.

Further, as used herein, in case a layer or an element is mentioned to be formed “on” layers or elements, it means that the layer or element is directly formed on the layers or elements, or it means that other layers or elements may be additionally formed between the layers, on an object, or on a substrate.

Although the present invention may have various forms and various modifications can be made thereto, specific examples will be exemplified and explained in detail. However, it is not intended to limit the present invention to any specific disclosed form, and it should be understood that all the modifications, equivalents or substitutions within the idea and technical scope of the present invention are included in the present disclosure.

Further, technical terms used herein are only for mentioning specific embodiments and they are not intended to restrict the present invention. The singular expressions used herein may include the plural expressions unless they are differently expressed contextually.

On the other hand, the term “polymer” as used herein refers to a compound produced by polymerizing monomer compounds, and includes both a homopolymer and a copolymer.

Further, as used herein, the alkyl group may be straight-chain or branched-chain, and the carbon number thereof is not particularly limited, but is preferably 1 to 10. According to one embodiment, the carbon number of the alkyl group is 1 to 6. According to another embodiment, the carbon number of the alkyl group is 1 to 4. Specific examples of the alkyl group include methyl, ethyl, propyl, n-propyl, isopropyl, butyl, n-butyl, isobutyl, tert-butyl, sec-butyl, 1-methylbutyl, 1-ethyl-butyl, pentyl, n-pentyl, isopentyl, neopentyl, tert-pentyl, 1-ethyl-propyl, 1,1-dimethylpropyl, hexyl, n-hexyl, 1-methylpentyl, 4-methyl-2-pentyl, 3,3-dimethylbutyl, 2-ethylbutyl, heptyl, n-heptyl, 1-methylhexyl, 2-methylhexyl, 3-methylhexyl, 4-methylhexyl, 5-methylhexyl, cyclopentylmethyl, cyclohexylmethyl, octyl, n-octyl, tert-octyl, 1-methylheptyl, 2-ethylhexyl, 2,4,4-trimethyl-1-pentyl, 2,4,4-trimethyl-2-pentyl, 2-propylpentyl, n-nonyl, 2,2-dimethylheptyl, and the like, but are not limited thereto.

Further, in the present invention, the description of the alkyl group as defined above can be applied except that the alkylene group is not a monovalent group but a divalent group.

In the present invention, the halogen means fluoro, chloro, bromo, or iodo.

In recent years, as the demand for fuel cells as a next-generation energy source has increased, interest in anion exchange membranes has increased in order to overcome the limitations of cation exchange membrane fuel cells. However, when the degree of crosslinking is increased in order to increase durability such as dimensional stability and alkali stability of an anion exchange membrane, there is a problem that ionic conductivity decreases.

In this regard, the present inventors have found that polymers in which a halogenated alkyl group is introduced into the side chain is produced by a hydrogenation reaction and an atom transfer radical polymerization reaction of a styrene-isoprene-styrene triblock copolymer, and then the polymers crosslinked with a diamine compound can lengthen a distance between the ionic bond and the main chain to improve ionic conductivity, and at the same time, fine phase separation is achieved through the formation of several tens of nanostructures, which facilitates the movement of ions through nanochannels, and the mechanical strength is far superior to that of a single polymer, thereby capable of producing an anion exchange membrane having improved durability, and completed the present invention.

Now, the novel polymer, a method for producing the same, an anion exchange membrane comprising the same, and a method for producing the anion exchange membrane according to specific embodiments of the invention will be described in more detail.

### Polymer and Method for Producing the Same

In one embodiment, a polymer comprising a crosslinked structure represented by the following Chemical Formula 1 is provided:

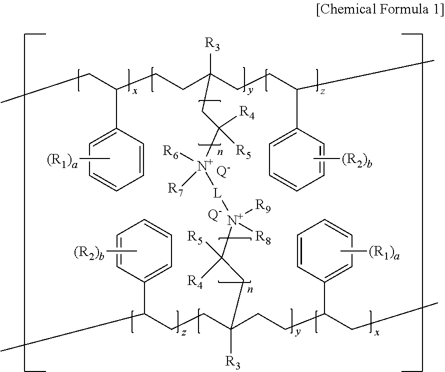

wherein, in Chemical Formula 1,
R₁ and R₂ are each independently halogen or a C₁₋₄ alkyl,
a and b are each independently an integer from 0 to 3,
R₃ and R₄ are each independently hydrogen or a C₁₋₄ alkyl,
R₅ is a C₁₋₁₀ alkyl,
R₆ to R₉ are each independently a C₁₋₄ alkyl,
L is a C₁₋₁₀ alkylene,
Q is halogen,
n is an integer from 1 to 3,
x, y and z each means the mole fraction of each repeating unit in the polymer, and x+y+z=1.

The polymer is an ionomer whose main chain in the polymer shows neutrality and whose side chain has an ionic bond, whereby the polymer exhibits ionic conductivity.

This polymer includes a crosslinked structure represented by Chemical Formula 1 and ultimately exhibits a shape of a membrane, and therefore the weight average molecular weight of the polymer can be considered unlimited. However, as an example, if the number of crosslinked structures represented by Chemical Formula 1 in the polymer is defined as m, m may be 1 to 100,000,000.

Further, the polymer may include not only a crosslinked structure represented by Chemical Formula 1, but also a non-crosslinked structure represented by the following Chemical Formula 2.

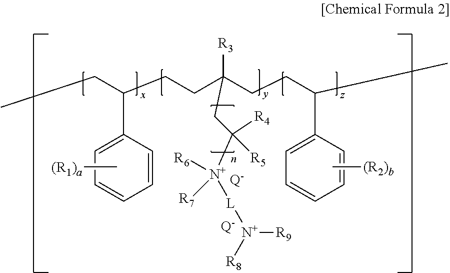

In other words, the polymer may have a partially crosslinked structure.

At this time, the crosslinked structure represented by Chemical Formula 1 and the non-crosslinked structure represented by Chemical Formula 2 may be included in the polymer at a molar ratio of 1:0.5 to 1:10.

Further, in Chemical Formula 1, a and b mean the number of R₁ and R₂, respectively. When a is 2 or more, two or more R₁ may be the same or different from each other, and when b is 2 or more, two or more R₂ may be the same or different from each other.

More specifically, R₁ and R₂ are each independently chloro, bromo, methyl, or tert-butyl, and a and b may be each independently 0 or 1.

At this time, R₁ and R₂ may be the same as each other, and
a and b may be the same as each other.

Further, R₃ and R₄ may be each independently hydrogen or methyl.

For example, R₃ may be methyl.

Further, for example, R₄ may be hydrogen.

Further, R₅ may be a C₁₋₁₀ alkyl.

For example, R₅ may be n-propyl, n-butyl, n-pentyl, n-hexyl, n-heptyl, or n-octyl.

Preferably, R₄ may be hydrogen, and
R₅ may be n-pentyl, n-hexyl, n-heptyl, or n-octyl.

Further, all of R₆ to R₉ may be the same.

For example, all of R₆ to R₉ may be methyl or ethyl.

Further, L may be a C₄₋₁₀ alkylene.

For example, L may be butylene, pentylene, hexylene, or heptylene.

Further, Q may be chloro(Cl).

In Chemical Formula 1, each of x, y and z is the value obtained by dividing the number of moles of the repeating unit within the parentheses by half of the number of moles of all repeating units in the crosslinked structure represented by Chemical Formula 1, and x+y+z is 1. Further, each of x, y and z is equal to the mole fraction of each block in the triblock copolymer used as a starting material for the preparation of the polymer containing the crosslinked structure represented by Chemical Formula 1. Specifically, when each block in the triblock copolymer is defined as A, B, and C, and the number of repetitions thereof is defined as a, b, and c, x may be calculated as a/(a+b+c), y as b/(a+b+c), and z as c/(a+b+c).

Specifically, x, y, and z are each independently a real number between more than 0 and less than 1.

More specifically, x and z may be each independently a real number between 0.01 and 0.5, and y may be a real number between 0.3 and 0.9.

For example, x is a real number between 0.1 and 0.25, y may be a real number from 0.5 to 0.8, and z may be a real number from 0.1 to 0.25.

Further, x+z may be 0.2 to 0.5. More specifically, x+z may be 0.2 or more, 0.21 or more. 0.22 or more, 0.23 or more, or 0.24 or more, and 0.5 or less, 0.45 or less, 0.4 or less, 0.35 or less, 0.3 or less, or 0.25 or less.

At this time, x and z may be the same as each other.

Further, y may be more specifically 0.5 or more, 0.55 or more, 0.6 or more, 0.65 or more, 0.7 or more, or 0.75 or more, and 0.8 or less, 0.79 or less, 0.78 or less, or 0.77 or less, 0.76 or less.

Further, the polymer may be derived from a triblock copolymer represented by the following Chemical Formula 1-1 having a weight average molecular weight of 50,000 to 400,000 g/mol:

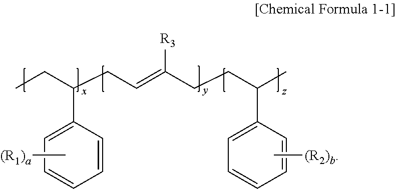

wherein, in Chemical Formula 1-1,
R₁, R₂, a, b, x, y and z are as defined in Chemical Formula 1.

In another embodiment, there is provided a method for producing a polymer comprising a crosslinked structure represented by Chemical Formula 1, which is produced through steps 1 to 3 of the following Reaction Scheme 1:

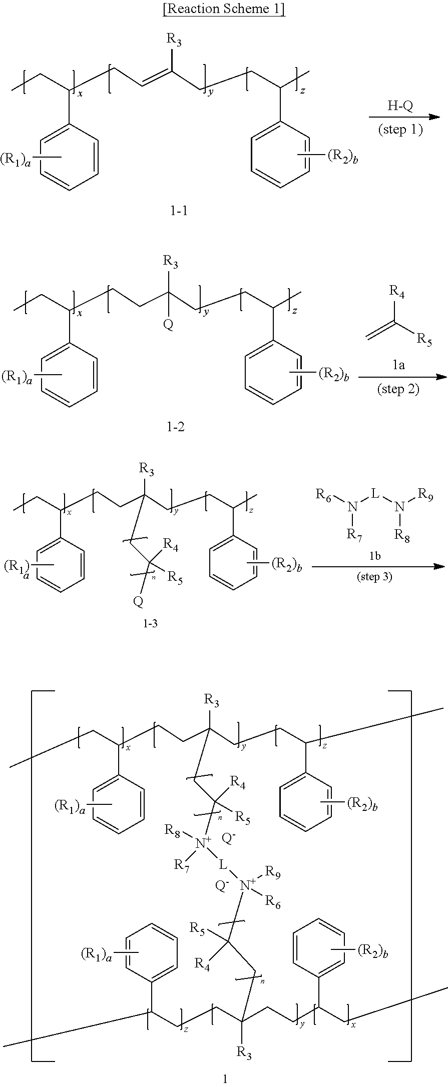

wherein, in Reaction Scheme,
R₁ to R₉, L, Q, a, b, n, x, y and z are as defined in Chemical Formula 1.

### (Step 1)

Step 1 is a step of reacting a first polymer, which is an A-B-C triblock copolymer represented by Chemical Formula 1-1, with a hydrogen halide (H-Q; where Q is halogen) to produce a second polymer, which is an A-B′-C triblock copolymer represented by Chemical Formula 1-2, wherein the reaction is a halogenation addition reaction in which a hydrogen halide is added to a double bond in the first polymer.

The first polymer represented by Chemical Formula 1-1 is an A-B-C triblock copolymer produced by copolymerization of a styrene-based monomer, a conjugated diene-based monomer having 4 carbon atoms, and a styrene-based monomer, and has a one-dimensional linear polymer structure in which repeating units are arranged in long chains. More specifically, in the first polymer, the A block means a block represented by the following Chemical Formula A, the B block means a block represented by the following Chemical Formula B, and the C block means a block represented by the following Chemical Formula C.

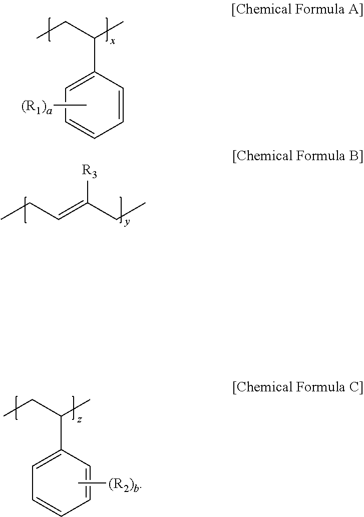

As an example, considering ease of synthesis and production costs, it is preferable that the first polymer represented by Chemical Formula 1-1 is a styrene-isoprene-styrene triblock copolymer (Styrene-b-Isoprene-b-Styrene; SIS).

Further, the first polymer may have a weight average molecular weight of 50,000 to 400,000 g/mol as described above. Here, the weight average molecular weight of the triblock copolymer can be determined according to gel permeation chromatography (GPC) using calibration curves created with polystyrene standards. More specifically, the weight average molecular weight (Mw, g/mol) of the polymer may be 50,000 or more, 60,000 or more, 70,000 or more, or 80,000 or more, and 400,000 or less, 300,000 or less, 200,000 or less, or 100,000 or less.

In the above step, the hydrogen halide may be used in an amount of 2 to 3 moles relative to 1 mole of the B block unit in the first polymer represented by Chemical Formula 1-1. If the hydrogen halide is used in an excessively low amount, there is a risk that the reaction time will become longer, and even if the hydrogen halide is used in an excessively large amount, there is no difference in reaction time, and thus, the hydrogen halide is preferably used within the above-mentioned range.

More specifically, in the above step, the hydrogen halide may be used in an amount of 2 moles or more, 2.1 moles or more, 2.2 moles or more, 2.3 moles, more, 2.4 moles, or more, or 2.5 mol or more, and 3 moles or less, or 2.95 mol or less relative to 1 mole of the B block unit in the first polymer represented by Chemical Formula 1-1.

Further, the reaction may be carried out in an organic solvent such as toluene, dichloromethane, chloroform, dimethylformamide, dioxane, tetrahydrofuran, or the like. Here, the organic solvent may be used in an amount (mL/g) of 5 to 20 times (volume) the weight of the first polymer represented by Chemical Formula 1-1, and more specifically, it may be used in an amount (mL/g) of 10 to 15 times (volume).

Further, the reaction can be carried out at 20 to 30° C. for 12 to 24 hours. The above range is preferable from the viewpoint of reaction rate and production yield.

### (Step 2)

Step 2 is a step of reacting a second polymer, which is an A-B′-C triblock copolymer represented by Chemical Formula 1-2, with an alkene represented by Chemical Formula 1a to produce a third polymer, which is an A-B″-C triblock copolymer represented by Chemical Formula 1-3, wherein the reaction proceeds by atom transfer radical polymerization (ATRM).

In the second polymer, the A block and the C block are the same as described above, and the B′ block means a block represented by the following Chemical Formula B′.

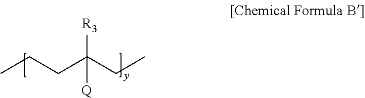

In the above step, the alkene represented by Chemical Formula 1a may be used in amounts of 10 to 100 moles relative to 1 mole of the B′ block unit in the second polymer represented by Chemical Formula 1-2. If the alkene is used in an excessively low amount, the length of the side chain may become short and thus, the durability of the membrane may be reduced, and if the alkene is used in an excessively large amount, there is a problem of inhibiting the reaction, and thus, the alkene is preferably used in the above-mentioned range. More specifically, in the above step, the alkene represented by Chemical Formula 1a may be used in an amount of 10 moles or more, 20 moles or more, 30 moles or more, or 40 moles or more, and 100 moles or less, 90 moles or less, 80 moles or less, 70 moles or less, or 60 moles or less relative to 1 mole of the B′ block unit in the second polymer represented by Chemical Formula 1-2.

Further, the reaction may be carried out in an organic solvent such as toluene, dichloromethane, chloroform, dimethylformamide, dioxane, dimethylformamide, tetrahydrofuran, or the like. Here, the organic solvent may be used in an amount (mL/g) of 10 to 30 times(volume) the weight of the second polymer represented by Chemical Formula 1-2, and more specifically, it can be used in an amount (mL/g) of 15 to 20 times (volume).

Further, the reaction may be carried out at 50 to 100° C. for 1 hour to 72 hours. The above-mentioned range is preferable from the viewpoint of reaction rate and producing yield.

### (Step 3)

Step 3 is a step of reacting a third polymer, which is an A-B″-C triblock copolymer represented by Chemical Formula 1-3, with a diamine represented by Chemical Formula 1b to produce a polymer comprising a crosslinked structure represented by Chemical Formula 1, wherein two third polymers represented by Chemical Formula 1-3 are crosslinked by diamine through the above reaction.

In the third polymer, the A block and the C block are the same as described above, and the B″ block means a block represented by the following Chemical Formula B″.

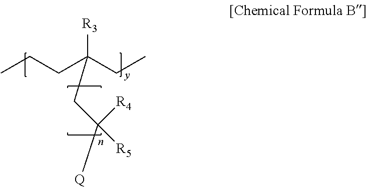

In the above step, the diamine represented by Chemical Formula 1b may be used in an amount of 0.1 to 0.3 mole relative to 1 mole of the B″ block unit in the third polymer represented by Chemical Formula 1-3. If the diamine is used in an excessively low amount, there is a risk that crosslinking decreases and thus, the mechanical properties of the membrane may deteriorate, and if the diamine is used in an excessively large amount, there is a risk that the ionic conductivity may decrease or the physical properties of the membrane may deteriorate due to residual unreacted diamine, and thus, diamine is preferable used in the above-mentioned range. More specifically, in the above step, the diamine represented by Chemical Formula 1b may be used in an amount of 0.1 mole or more, 0.11 mole or more, 0.12 mole or more, 0.13 mole or more, or 0.14 mole or more, and 0.3 mole or less, 0.25 mole or less, 0.2 mole or less, 0.19 mole or less, 0.18 mole or less, 0.17 mole or less, or 0.16 mole or less, relative to 1 mole of the B″ block unit in the third polymer represented by Chemical Formula 1-3.

Further, the reaction may be carried out in one or more organic solvents selected from the group consisting of tetrahydrofuran, chloroform, dichloromethane, and toluene. Here, the organic solvent may be used in an amount (mL/g) of 10 to 30 times (volume) the weight of the third polymer represented by Chemical Formula 1-3, and more specifically, it may be used in an amount (mL/g) of 15 to 25 times (volume).

Further, the reaction may be carried out by stirring at 20 to 30° C. for 1 minute to 3 hours.

More specifically, after the stirring, the organic solvent is removed under vacuum at 40 to 80° C. for 12 to 24 hours, and then the reaction is further carried out under vacuum at 80 to 150° C. for 24 to 72 hours.

### Anion Exchange Membrane and Method for Producing the Same

On the other hand, in another embodiment, there is provided an anion exchange membrane comprising a polymer including a crosslinked structure represented by Chemical Formula 1.

In yet another embodiment, there is provided a method for producing the above-described anion exchange membrane, comprising the following steps 1 to 3. reacting a third polymer represented by Chemical Formula 1-3 with a diamine represented by Chemical Formula 1b in an organic solvent to produce a polymer solution comprising a crosslinked structure represented by Chemical Formula 1 (step 1); and
casting the polymer solution onto a substrate and then drying the casted film (step 2).

### (Step 1)

Step 1 is a step of crosslinking the third polymer represented by Chemical Formula 1-3 using a diamine compound as a crosslinking agent in an organic solvent, and producing it in the form of a polymer solution to facilitate the coating operation for producing in the form of a film.

In step 1, the organic solvent may be one or more selected from the group consisting of tetrahydrofuran, chloroform, dichloromethane, and toluene. Here, the organic solvent may be used in an amount (mL/g) of 10 to 30 times (volume) the weight of the third polymer represented by Chemical Formula 1-3, and more specifically, it may be used in an amount (mL/g) of 15 to 25 times (volume).

### (Step 2)

Further, step 2 is a step of casting the polymer solution onto a substrate and then drying the casted film. In the above step, the polymer solution is applied to a substrate to a certain thickness and then dried to remove the organic solvent of step 1, thereby producing a film-type membrane.

The substrate used at this time can be a glass substrate that can easily release the cast anion exchange membrane. Further, the polymer solution may be applied onto the substrate to a thickness of 20 to 80 μm.

Further, the drying in step 2 may be carried out at 40 to 80° C. for 12 to 24 hours. Specifically, the drying may proceed through vacuum drying, and the organic solvent in step 1 can be completely removed by the drying step.

Further, after step 2, a step of heat treatment at 80 to 150° C. for 24 to 72 hours may be further carried out. The heat treatment may proceed in a vacuum, and a crosslinking reaction may further proceed through the heat treatment step.

The anion exchange membrane produced through this process can be produced to a thickness of 20 to 80 μm.

On the other hand, in another embodiment, there is provided a fuel cell including the anion exchange membrane described above.

Furthermore, in another embodiment, there is provided an alkaline electrolysis cell including the anion exchange membrane described above.

Hereinafter, the preferred examples are provided for better understanding the present invention. However, these examples are for illustrative purposes only, and the scope of the invention is not limited to or by them.

### Example 1: Production of a Polymer Containing a Crosslinked Structure Represented by XL-SIS-Hex-Cl and an Anion Exchange Membrane Containing the Same

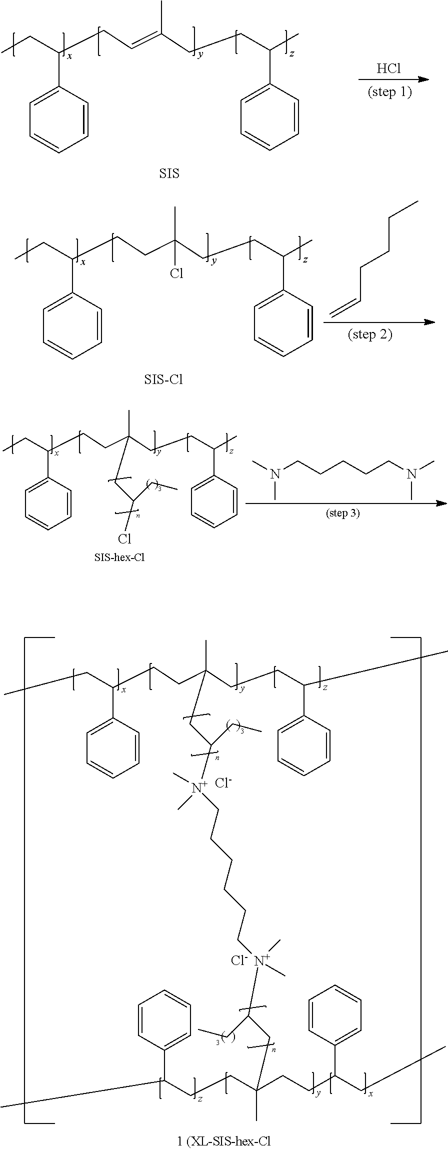

### (Step 1) Hydrochlorination

In a 250 mL flask, 5 g of the first polymer, i.e., styrene-isoprene-styrene triblock copolymer (Styrene-b-Isoprene-b-Styrene; SIS, number of each block in the copolymer—styrene (136), isoprene (838), styrene (136); x=0.1225, y=0.7550, z=0.1225); Mw=90,000 g/mol) (number of moles of isoprene which is the B block in 5 g: 0.04194 mmol), toluene 120 mL, hydrogen chloride 120 mL dissolved in acetic acid (pure hydrogen chloride: 3 mL, 0.1226 mmol, 2.923 mol relative to 1 mole of isoprene) and a magnetic bar were added, and the mixture was allowed to react at room temperature for 24 hours. After completion of the reaction, precipitates were collected in 5 L of methanol, then precipitates were collected in 5 L of methanol again, water and solvent were removed under vacuum at room temperature, and a chloro group-substituted styrene-isoprene-styrene second polymer (SIS-Cl) was obtained.

### (Step 2) ATRP (Alkylation)

In a 250 mL flask, 5 g of the second polymer (SIS-Cl) obtained in step 1 (number of moles of isoprene-derived B′ blocks in 5 g: 31.765 mmol), toluene 200 mL, 1-hexene 196.9 mL, 1588.5 mmol, 50 moles relative to 1 mole of the B′ block), 1.8 g of copper(I) bromide, 2.6 mL of pentamethyldiethylenetriamine and a magnetic bar were added, and the mixture was allowed to react at 60° C. for 1.5 hours. After completion of the reaction, the solution was filtered through an aluminum oxide column and the solvent was removed under vacuum at 60° C. Then, precipitates were collected in 2 L of methanol, then precipitates were collected in 2 L of methanol again, and water and solvent were removed under vacuum at room temperature to obtain a third polymer styrene-isoprene-styrene (SIS-hex-Cl) containing a 1-hexene unit and having a chloro group substituted at the end of the side chain.

### (Step 3) Crosslinking

In a 20 mL vial, 0.3 g of the third polymer (SIS-hex-Cl) obtained in step 2 (number of moles of isoprene-derived B″ blocks in 0.3 g: 1.88 mmol), organic solvent tetrahydrofuran 6 mL, N,N,N′,N′-tetramethyl-1,6-hexanediamine 0.0487 g, 0.283 mmol, 0.15 mole relative to 1 mole of B″ block) and a magnetic bar were added, and the mixture was stirred at room temperature for 5 minutes to produce a polymer solution containing the crosslinked structure represented by XL-SIS-hex-Cl.

Subsequently, the polymer solution was uniformly applied to a Petri dish with a diameter of 9 cm to a thickness of 60 μm, casted, and dried in a vacuum at 60° C. for 24 hours to remove the solvent, thereby producing a membrane.

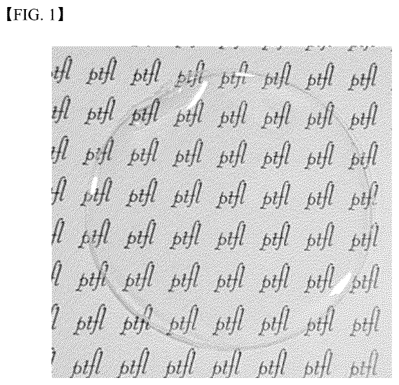

Next, the above membrane was heat-treated in a vacuum state at 100° C. for 48 hours to further advance the reaction, thereby obtaining a transparent anion exchange membrane (XL-SIS-hex-QA) with a thickness of 30 μm, a photograph of which is shown in FIG. 1.

### Test Example 1: ¹H NMR Analysis

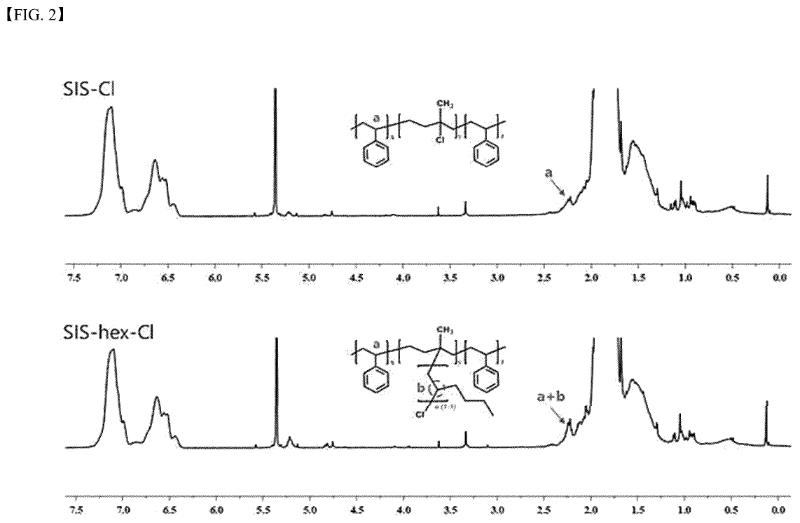

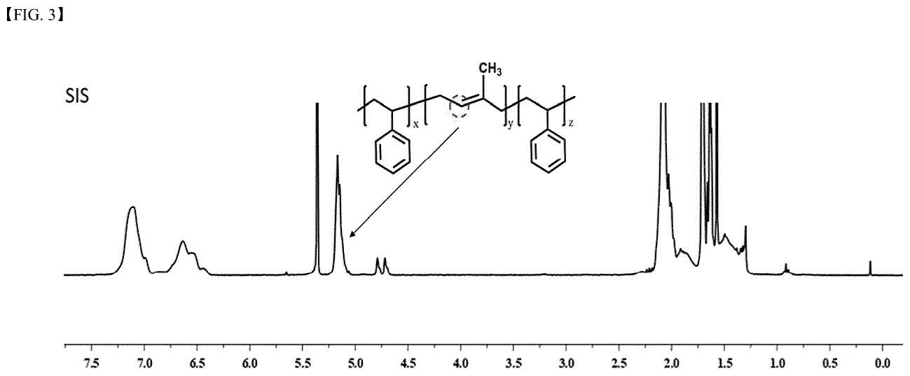

¹H NMR analysis spectra of the second polymer (SIS-Cl) and the third polymer (SIS-hex-Cl) produced in steps 1 and 2 of Example 1 are shown in FIG. 2. Also, to confirm whether the synthesis progressed well, the ¹H NMR analysis spectrum of the first polymer (SIS) is shown in FIG. 3. At this time, ¹H NMR spectra were obtained on an Agilent 400-MR (400 MHz) instrument using CDCl₃ as reference or internal deuterium locking device.

Comparing the spectrum of the second polymer(SIS-Cl) in FIG. 2 and the spectrum of the first polymer(SIS) in FIG. 3, it can be seen that in the case of the first polymer(SIS) in FIG. 3, the intensity of the peak at 4.5 to 5.3 ppm due to isoprene groups is high, whereas in the case of the second polymer(SIS-Cl) in FIG. 2, the peaks due to isoprene groups hardly appear. This means that the synthesis from the first polymer to the second polymer was carried out satisfactorily, and the conversion rate of the synthesis from the first polymer to the second polymer, which was calculated according to the ratio of the peaks of the isoprene group, was 98% or more.

Comparing the spectrum of the second polymer (SIS-Cl) and the third polymer (SIS-hex-Cl) in FIG. 2, it can be seen that in the case of the third polymer (SIS-hex-Cl), the peak at 2.2 ppm appearing at the third carbon shows a stronger intensity than the peak at 2.2 ppm of the second polymer (SIS-Cl).

Since this is due to the carbon represented by b which was introduced by the 1-hexene compound, it can be confirmed through comparison of these peaks that the synthesis of the third polymer from step 2 of Example 1 was carried out successfully.

On the other hand, the n value in the third polymer (SIS-hex-Cl) produced in step 2 of Example 1 can be confirmed by obtaining the integral value of the peak represented by a and the integral value of the peak represented by a+b in the 1H NMR analysis spectra of the second polymer (SIS-Cl) and the third polymer (SIS-hex-Cl). As a result of confirmation, n had a value of 1 to 3.

### Test Example 2: FT-IR Analysis

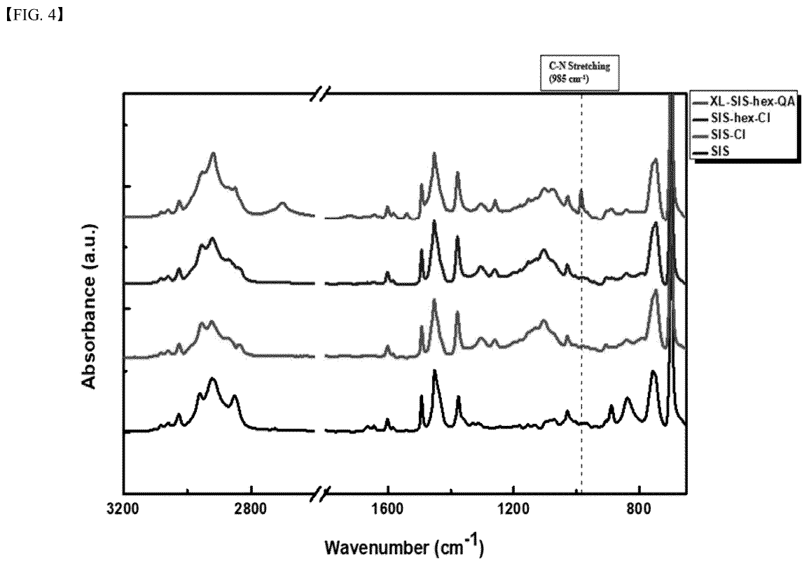

FT-IR analysis was carried out for each of the first polymer (SIS), which is the starting material of Example 1, and the second polymer (SIS-Cl), the third polymer (SIS-hex-Cl) and the anion exchange membrane (Xl-SIS-hex-QA) produced in Example 1, and the results are shown in FIG. 4.

Referring to FIG. 4, comparing the spectrum of the third polymer (SIS-hex-Cl) and the spectrum of the anion exchange membrane (Xl-SIS-hex-QA), it can be seen that in the case of the third polymer (SIS-hex-Cl), the peak at 985 cm¹ due to carbon-nitrogen bond in the quaternary ammonium structure does not appear, whereas in the case of the anion exchange membrane (Xl-SIS-hex-QA), the intensity of the peak due to the carbon-nitrogen bond in the quaternary ammonium structure is high. Thereby, it can be confirmed that an anion exchange membrane (Xl-SIS-hex-QA) with a quaternary ammonium structure was successfully produced from the third polymer (SIS-hex-Cl).

### Test Example 3: Measurement of Performance of Anion Exchange Membrane

The ion exchange ability of the anion exchange membrane produced in Example was measured by comparing and calculating the relative integral width between the protons of the aromatic and methyl groups in the ¹H NMR spectrum. This is shown in Table 1 in comparison with a commercially available anion exchange membrane (Fumasep® FAA-3-50, produced by Fumatech).

Further, the moisture content and swelling degree of the anion exchange membrane and FAA-3-50 produced in Example were measured in OH⁻ form. Specifically, after ion exchange, a specific form of membrane was washed several times with ultrapure water, and then the hydrated membrane was quickly wiped with a filter paper to remove water on the surface. Then, the weight (m_{wet}) and unidirectional length (L_{wet}) of the hydrated membrane were recorded, then the filter paper was covered to prevent the membrane from shrinking, and dried in a vacuum oven at 90° C. for 24 hours to maintain a constant weight. The weight (m_{dry}) and unidirectional length (L_{dry}) of the dried membrane were then immediately recorded. Finally, the moisture content and swelling degree were calculated according to the following Equations 1 and 2, respectively, and the results are shown in Table 1 below.

$$Moisture content ( \% ) = [ ( {m}_{wet} - {m}_{dry} ) / {m}_{dry} ] \times 100 \qquad [ Equation 1 ]$$

$$Swelling degree ( \% ) = [ ( {L}_{wet} - {L}_{dry} ) / {L}_{dry} ] \times 100 \qquad [ Equation 2 ]$$

Further, the ion conductivity of the anion exchange membrane and FAA-3-50 produced in Example was determined under the 80° C./100% RH conditions after measuring the thickness of each anion exchange membrane using high-purity DI water from Deoksan Chemicals, and then connecting 4 probe conductivity cells from Bekktech to AC impedance, and the results are shown in Table 1 below.

TABLE 1

| | | | | | Moisture | Swelling | Ion |
|---|---|---|---|---|---|---|---|
| | | | | | content | degree | conductivity |
| | Anion exchange | IEC (meq./g) | | Reactivity | (%) | (%) | (mS/cm) |
| | membrane | Theo. | Exp. | (%) | @ 25° C. | @ 25° C. | @ 25° C. |
| Example 1 | XL-SIS-hex-QA | 2.54 | 2.00 | 78.74 | 20.1 | 12.7 | 3.5 |
| Comparative | FAA-3-50 | 1.85 | 1.72 | 92.97 | 16.3 | 3.6 | 3.0 |
| Example 1 | | | | | | | |

Referring to Table 1, it can be confirmed that the anion exchange membrane comprising the polymer containing a crosslinked structure represented by Chemical Formula 1 of Example 1 exhibits improved ion exchange performance, moisture content, swelling degree, and ionic conductivity as compared to the anion exchange membrane (FAA-3-50) of Comparative Example 1.

1. A polymer comprising a crosslinked structure represented by the following Chemical Formula 1: 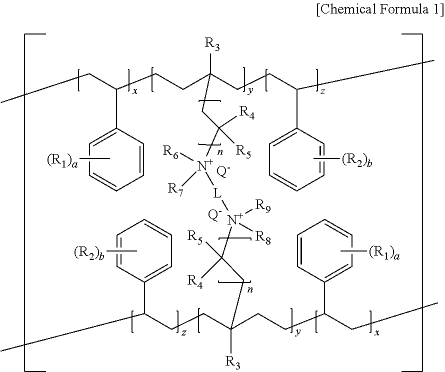
wherein, in Chemical Formula 1,
R₁ and R₂ are each independently halogen or a C₁₋₄ alkyl,
a and b are each independently an integer from 0 to 3,
R₃ and R₄ are each independently hydrogen or a C₁₋₄ alkyl,
R₅ is a C₁₋₁₀ alkyl,
R₆ to R₉ are each independently a C₁₋₄ alkyl,
L is a C₁₋₁₀ alkylene,
Q is halogen,
n is an integer from 1 to 3, and
x, y and z each means the mole fraction of each repeating unit in the polymer, and
$$x + y + z = 1 .$$

2. The polymer according to claim 1, wherein:
R₁ and R₂ are each independently chloro, bromo, methyl, or tert-butyl, and
a and b are each independently 0 or 1.

3. The polymer according to claim 1, wherein:
R₃ is methyl.

4. The polymer according to claim 1, wherein:
R₄ is hydrogen, and
R₅ is n-propyl, n-butyl, n-pentyl, n-hexyl, n-heptyl, or n-octyl.

5. The polymer according to claim 1, wherein:
R₆ to R₉ are all methyl or ethyl.

6. The polymer according to claim 1, wherein:
L is butylene, pentylene, hexylene, or heptylene.

7. The polymer according to claim 1, wherein:
Q is chloro.

8. The polymer according to claim 1, wherein:
x+z is 0.2 to 0.5.

9. The polymer according to claim 1, wherein:
the polymer is derived from a triblock copolymer represented by the following Chemical Formula 1-1 having a weight average molecular weight of 50,000 to 400,000/mol. 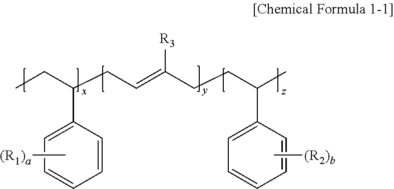
wherein, in Chemical Formula 1-1,
R₁, R₂, a, b, x, y and z are as defined in claim 1.

10. A method for producing a polymer comprising a crosslinked structure represented by the following Chemical Formula 1, the method comprising the steps of:
reacting a first polymer, which is an A-B-C triblock copolymer represented by the following Chemical Formula 1-1, with a hydrogen halide to produce a second polymer, which is an A-B′-C triblock copolymer represented by the following Chemical Formula 1-2 (step 1);
reacting a second polymer represented by the following Chemical Formula 1-2 with an alkene represented by the following Chemical Formula 1a to produce a third polymer, which is an A-B″-C triblock copolymer represented by the following Chemical Formula 1-3 (step 2); and
reacting a third polymer represented by the following Chemical Formula 1-3 with a diamine represented by the following Chemical Formula 1b to produce a polymer comprising a crosslinked structure represented by the following Chemical Formula 1 (step 3): 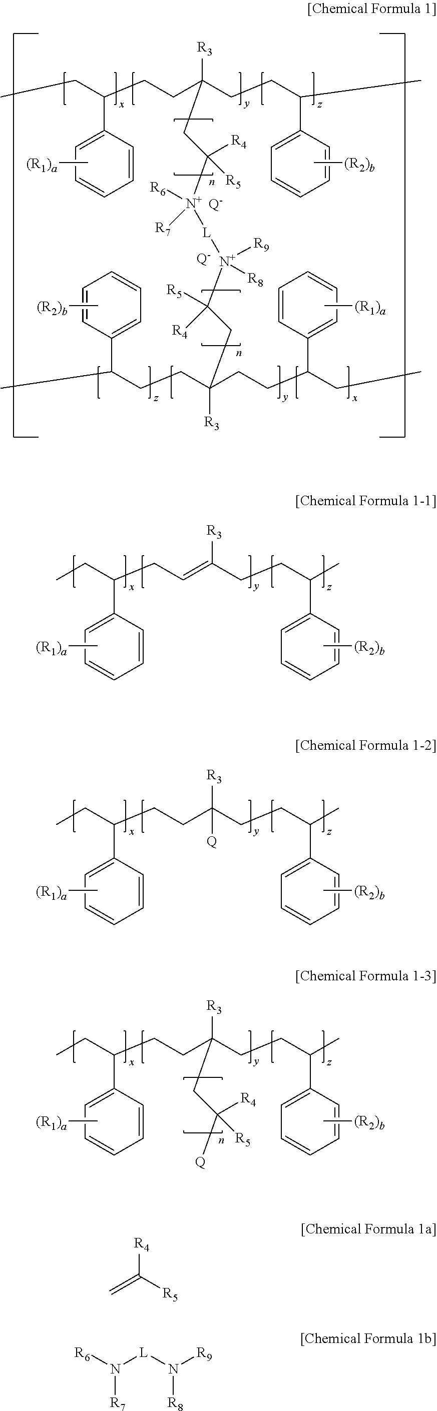
wherein, in Chemical Formulas 1, 1-1 to 1-3, 1a and 1b,
R₁ and R₂ are each independently halogen or a C₁₋₄ alkyl,
a and b are each independently an integer from 0 to 3,
R₃ and R₄ are each independently hydrogen or a C₁₋₄ alkyl,
R₅ is a C₁₋₁₀ alkyl,
R₆ to R₉ are each independently a C₁₋₄ alkyl,
L is a C₁₋₁₀ alkylene,
Q is halogen,
n is an integer from 1 to 3, and
x, y and z each means the mole fraction of each repeating unit in the polymer, and x+y+z=1.

11. The method according to claim 10, wherein:
in step 1, the hydrogen halide is used in an amount of 2 to 3 moles relative to 1 mole of the B block unit in the first polymer represented by Chemical Formula 1-1.

12. The method according to claim 10, wherein:
in step 2, the alkene represented by Chemical Formula 1a is used in an amount of 10 to 100 moles relative to 1 mole of the B′ block unit in the second polymer represented by Chemical Formula 1-2.

13. The method according to claim 10, wherein:
the reaction in step 2 is carried out at 50 to 100° C. for 1 hour to 72 hours.

14. The method according to claim 10, wherein:
in step 3, the diamine represented by Chemical Formula 1b is used in an amount of 0.1 to 0.3 mole relative to 1 mole of the B″ block unit in the third polymer represented by Chemical Formula 1-3.

15. (canceled)

16. A method for producing an anion exchange membrane, the method comprising the steps of:
reacting a third polymer represented by the following Chemical Formula 1-3 with a diamine represented by the following Chemical Formula 1b in an organic solvent to produce a polymer solution comprising a crosslinked structure represented by the following Chemical Formula 1 (step 1); and
casting the polymer solution onto a substrate and then drying the casted film (step 2). 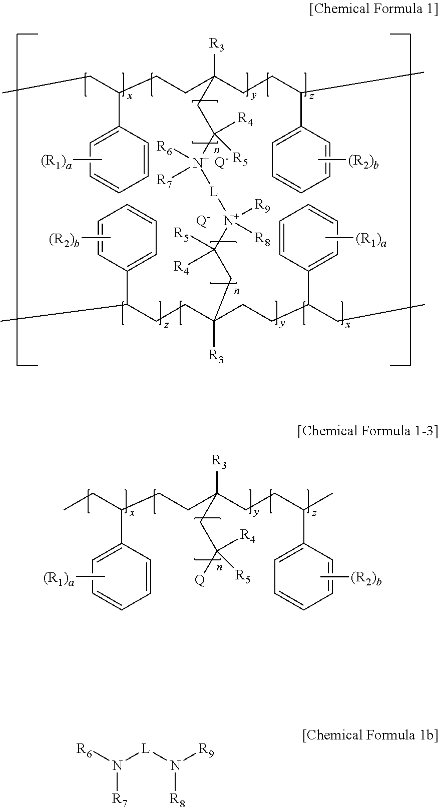
wherein, in Chemical Formulas 1, 1-3 and 1b,
R₁ and R₂ are each independently halogen or a C₁₋₄ alkyl,
a and b are each independently an integer from 0 to 3,
R₃ and R₄ are each independently hydrogen or a C₁₋₄ alkyl,
R₅ is a C₁₋₁₀ alkyl,
R₆ to R₉ are each independently a C₁₋₄ alkyl,
L is a C₁₋₁₀ alkylene,
Q is halogen,
n is an integer from 1 to 3, and
x, y and z each means the mole fraction of each repeating unit in the polymer, and x+y+z=1.

17. The method according to claim 16, wherein:
in step 1, the organic solvent is one or more selected from the group consisting of tetrahydrofuran, chloroform, toluene, and dichloromethane.

18. The method according to claim 16, wherein:
the drying in step 2 is carried out at 40 to 80° C. for 12 to 24 hours.

19. The method according to claim 16, wherein:
after step 2, a heat treatment step is further carried out at 80 to 150° C. for 24 to 72 hours.

20. The method according to claim 16, wherein:
the anion exchange membrane is produced to a thickness of 20 to 80 μm.
